(19) United States
(12) Patent Application Publication
(10) Pub. No.: US 2018/0239289 A1
(43) Pub. Date: Aug. 23, 2018

(54) IMAGE FORMING APPARATUS AND CONTROLLING METHOD THEREOF

(71) Applicants: KABUSHIKI KAISHA TOSHIBA, Tokyo (JP); TOSHIBA TEC KABUSHIKI KAISHA, Tokyo (JP)

(72) Inventor: Setsuo TAKADA, Izunokuni Shizuoka (JP)

(21) Appl. No.: 15/698,472

(22) Filed: Sep. 7, 2017

(30) Foreign Application Priority Data
Feb. 20, 2017 (JP) 2017-029255

(51) Int. Cl. G03G 15/00

(52) U.S. Cl. CPC G03G 15/5062

(57) ABSTRACT

An image forming apparatus includes an image forming unit, a first reader/writer device, a second reader/writer device, and a control unit. The first reader/writer device executes a wireless read/write operation on a wireless tag and is positioned in a sheet conveying path upstream of the image forming unit. The second reader/writer device executes a wireless read/write operation on a wireless tag and is positioned in the sheet conveying path downstream of the image forming unit. The control unit controls the image forming unit, the first reader/writer device, and the second reader/writer device. The control unit controls the second reader/writer device to perform an operation to detect a defect in a wireless tag that is included in a sheet as the sheet is conveyed along the sheet conveying path past the location of the second reader/writer device.

### CROSS-REFERENCE TO RELATED APPLICATION

This application is based upon and claims the benefit of priority from Japanese Patent Application No. 2017-029255, filed Feb. 20, 2017, the entire contents of which are incorporated herein by reference.

### FIELD

Embodiments described herein relate generally to an image forming apparatus.

### BACKGROUND

There is an image forming apparatus which forms an image on a sheet in which a wireless tag (e.g., Radio Frequency (RF) tag) is embedded. The image forming apparatus reads the data stored in the wireless tag embedded in the sheet or writes data to the wireless tag. Reading or writing of data with respect to the wireless tag is performed in a reading/writing unit (hereinafter, referred to as an “RW unit”) located near a conveying path of sheets.

Some of the wireless tags embedded in the sheet are already defective before the sheet is printed in the image forming apparatus. The image forming apparatus detects a defect of the wireless tag by the RW unit located near the conveying path of the sheet before image formation. If a defect is detected, the image forming apparatus prints a defect mark, which indicates that the wireless tag is defective, on the sheet (hereinafter, referred to as “void printing”). By printing the defect mark, it is possible to visually recognize the sheet with the defective wireless tag. However, if a task of sorting out by visual inspection of printed sheets occurs, this may result in a reduction in working efficiency.

The image forming apparatus of an electrophotographic system applies heat and pressure to the sheet by a fixing unit to fix a toner image onto the sheet. Therefore, the wireless tag embedded in the sheet may be damaged by the heat or the pressure. Accordingly, the wireless tag whose defect has not been detected before image formation may become defective after the image formation due to the heat or the pressure and there is a possibility that a sheet with a defective wireless tag is mixed into the printed sheets.

When printing a plurality of pages, if a defect of the wireless tag is detected, the image forming apparatus prints image of a page, which was going to be printed on a sheet in which the defect is detected, on the next sheet in which no defect is detected. As a result, it is possible to prevent a sheet in which the defect is detected from being printed. However, in the image forming apparatus of an electrophotographic system, it takes time from start of development to start of transfer. Accordingly, if an image to be printed is determined and development has started after checking that a defect of the wireless tag is not detected, the processing speed of printing (PPM or the like) decreases.

### DESCRIPTION OF THE DRAWINGS

FIG. 1 is a side view of an image forming apparatus of an embodiment.

FIG. 2 is a functional block diagram of the image forming apparatus of the embodiment.

FIG. 3 shows an operation mode of the image forming apparatus of the embodiment.

FIG. 4 is a flowchart depicting an operation of the image forming apparatus of the embodiment.

FIG. 5 is a flowchart depicting a void printing operation of the image forming apparatus of the embodiment.

FIG. 6 is a flowchart depicting a defect sorting operation of the image forming apparatus of the embodiment.

### DETAILED DESCRIPTION

In general, according to one embodiment, there is provided an image forming apparatus capable of improving a printing speed without a sheet with a defective wireless tag being mixed into the printed sheets.

The image forming apparatus of the embodiment includes an image forming unit, a first reader/writer device, a second reader/writer device, and a control unit. The first reader/writer device executes a wireless read/write operation on a wireless tag and is positioned in a sheet conveying path upstream of the image forming unit. The second reader/writer device executes a wireless read/write operation on a wireless tag and is positioned in the sheet conveying path downstream of the image forming unit. The control unit controls the image forming unit, the first reader/writer device, and the second reader/writer device. The control unit controls the second reader/writer device to perform an operation to detect a defect in a wireless tag that is included in a sheet as the sheet is conveyed along the sheet conveying path past the location of the second reader/writer device.

Hereinafter, an image forming apparatus of an embodiment will be described with reference to the drawings. In the following description, the same reference numerals are given to components that have the same or similar functions. In addition, the description of a duplicated configuration may be omitted.

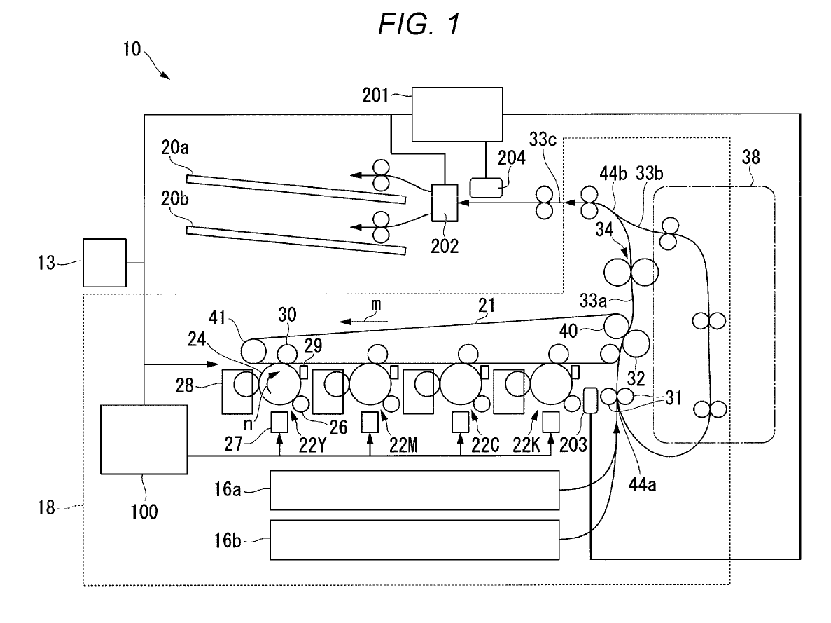

First, a side view of the image forming apparatus of the embodiment will be described with reference to FIG. 1.

In FIG. 1, an image forming apparatus 10 includes a control panel 13, a wireless tag control unit 201, a sheet discharge switching unit 202 which is, for example, a flapper that is controlled to be in one of two positions, a first RW (read/write) unit 203, a second RW unit 204, and a printer unit 18. The printer unit 18 includes a control unit 100, and paper feed cassettes 16a and 16b. The control unit 100 controls the control panel 13, the wireless tag control unit 201, the sheet discharge switching unit 202, and the printer unit 18. The control unit 100 controls the conveyance of the sheet in the printer unit 18. The control of conveyance of sheets is to control a sheet conveying timing, a sheet stop position, a sheet conveying speed, and the like.

The control panel 13 includes input keys and a display unit. For example, the input keys receive an operation input by the user. For example, the display unit is of a touch panel type. The display unit receives an operation input by the user and displays information to the user. For example, the control panel 13 displays items related to the operation of the image forming apparatus 10 on a display unit in a settable manner. The control panel 13 notifies the control unit 100 of the items set by the user. The control panel 13 allows the user to select the operation mode by displaying the operation items to be described later in a settable manner.

The paper feed cassette 16a accommodates, for example, a sheet having the wireless tag (hereinafter, referred to as a “wireless tag sheet”). The paper feed cassette 16b accommodates, for example, a normal sheet not having the wireless tag (hereinafter, referred to as a “regular sheet”). In a case where there is no distinction between the wireless tag sheet and the regular sheet, a word “sheet” is used. The sheet is formed of, for example, a material such as paper, plastic film or the like.

The printer unit 18 performs an image forming operation. For example, the printer unit 18 forms an image indicated by image data on a sheet (e.g., wireless tag sheet or regular sheet). In the following description, forming an image on a sheet is also referred to as printing. The printer unit 18 includes an intermediate transfer belt 21. The printer unit 18 supports the intermediate transfer belt 21 with a driven roller 41 and a backup roller 40 or the like. The printer unit 18 rotates the intermediate transfer belt 21 in the direction of an arrow m.

The printer unit 18 includes 4 sets of image forming stations 22Y, 22M, 22C, and 22K. Each of the image forming stations 22Y, 22M, 22C, and 22K is used for image formation of Y (yellow), M (magenta), C (cyan), and K (black). The image forming stations 22Y, 22M, 22C, and 22K are located under the intermediate transfer belt 21 and along the direction of rotation of the intermediate transfer belt 21.

Hereinafter, the image forming station 22Y of Y (yellow) among the respective image forming stations 22Y, 22M, 22C, and 22K will be described as an example. Since the image forming stations 22M, 22C and 22K include the same configuration as that of the image forming station 22Y, a detailed description thereof will be omitted.

The image forming station 22Y includes an electrostatic charger 26, an exposure scanning head 27, a developing device 28, and the photoconductive drum cleaner 29. The electrostatic charger 26, the exposure scanning head 27, the developing device 28 and the photoconductive drum cleaner 29 are arranged along an outer circumferential surface of a photoconductive drum 24 that rotates in the direction of an arrow n.

The image forming station 22Y includes a primary transfer roller 30 located on the side of inner circumferential surface of the intermediate transfer belt 21. The primary transfer roller 30 presses the inner circumferential surface of the intermediate transfer belt 21 such that the outer circumferential surface of the intermediate transfer belt 21 is pressed to the photoconductive drum 24 of the image forming station 22Y.

The image forming station 22Y exposes the outer circumferential surface of the photoconductive drum 24 by the exposure scanning head 27 after charging the outer circumferential surface of the photoconductive drum 24 with the electrostatic charger 26. The image forming station 22Y forms an electrostatic latent image on the photoconductive drum 24. The developing device 28 develops the electrostatic latent image on the photoconductive drum 24 using a two-component developer including a toner and a carrier.

The primary transfer roller 30 primarily transfers a toner image formed on the photoconductive drum 24 onto the outer circumferential surface of the intermediate transfer belt 21. The image forming stations 22Y, 22M, 22C, and 22K form color toner images on the intermediate transfer belt 21 by the primary transfer roller 30. The color toner images are formed by sequentially superimposing toner images of Y (yellow), M (magenta), C (cyan) and K (black) on the outer circumferential surface of the intermediate transfer belt 21. The photoconductive drum cleaner 29 removes the toner remaining on the photoconductive drum 24 after the primary transfer.

The printer unit 18 includes a secondary transfer roller 32. The secondary transfer roller 32 faces the backup roller 40 across the intermediate transfer belt 21. The secondary transfer roller 32 secondarily transfers the color toner images on the intermediate transfer belt 21 onto the sheet collectively. In the following description, a “toner image” may be either a color toner image or a toner image of only one color. The toner image may be a toner image using decolorable toner in a case where one of the developing devices 28 develops the electrostatic latent image on the photoconductive drum 24 using a two-component developer including a decolorable toner and a carrier.

A conveying path 33a is a conveying path from a merging portion 44a to a branching portion 44b. A conveying path 33b is a conveying path that passes through the inside of a duplex printing device 38 and is a conveying path from the branching portion 44b to the merging portion 44a. A conveying path 33c is a conveying path from the branching portion 44b to the sheet discharge switching unit 202 of a wireless tag unit 200.

The leading end of the sheet fed from the paper feed cassette 16a or the paper feed cassette 16b is brought into contact with a nip portion of a pair of registration rollers 31 which are stopped. As the sheet is conveyed while the leading end thereof is contacting with the nip portion of the registration roller 31, the skew of the sheet is corrected. The control unit 100 starts to rotate the registration roller 31 in accordance with the position of the toner image formed on the intermediate transfer belt 21 rotating and conveys the sheet to the position of the secondary transfer roller 32. The control unit 100 secondarily transfers the toner image formed on the intermediate transfer belt 21 onto the sheet by the secondary transfer roller 32. The control unit 100 conveys the sheet to the conveying path 33a and forms an image by fixing the toner image on the sheet by a fixing device 34. The control unit 100 discharges the sheet by conveying the sheet on which the toner image is fixed to the conveying path 33c.

In the case of duplex printing, the control unit 100 conveys the sheet on which the toner image is fixed to the conveying path 33c. Next, the control unit 100 switches back and conveys the sheet on which the toner image is fixed to the conveying path 33b after the entire sheet has passed through the branching portion 44b. Thereafter, the control unit 100 conveys the sheet to the merging portion 44a via the conveying path in the duplex printing device 38 and conveys the sheet to the conveying path 33a again via the registration roller 31. Then, the control unit 100 forms an image on the back side of the sheet by fixing a toner image by the fixing device 34. The control unit 100 discharges the sheet by conveying the sheet which images are formed on both sides thereof to the conveying path 33c.

In the present embodiment, the conveying path 33b is also used as a conveying path for withdrawing a sheet. Specifically, the control unit 100 first conveys the sheet having an image fixed on the surface thereof to the conveying path 33c. The control unit 100 causes the entire sheet to pass through the branching portion 44b and switch back to the conveying path 33b, and conveys the sheet until the entire sheet passes through the branching portion 44b. As a result, since the sheet is withdrawn from the conveying path 33a, the control unit 100 can convey other sheets from the conveying path 33a to the conveying path 33c. When discharging the withdrawn sheet, unlike in the case of duplex printing, the control unit 100 conveys the sheet toward the branching portion 44b and conveys the sheet to the conveying path 33c as it is to discharge the sheet. In the following description, conveying a sheet on which an image is formed from the conveying path 33a to the conveying path 33c without withdrawing is referred to as normal conveyance. In addition, conveying for withdrawing a sheet on which an image is fixed is referred to as withdrawal conveyance.

The wireless tag control unit 201 includes a control circuit (not shown) and a storage device (not shown). The wireless tag control unit 201 controls the first RW unit 203 and the second RW unit 204. The wireless tag control unit 201 can communicate with the control unit 100.

The first RW unit 203 and the second RW unit 204 are each a reader/writer device (e.g., an RFID reader/writer) that wirelessly reads information stored in the wireless tag included in the wireless tag sheet or writes information to the wireless tag. In the first RW unit 203 and the second RW unit 204, an operation of executing at least one of reading and writing of information with respect to the wireless tag is referred to as a “read/write operation”. That is, a read/write operation includes a single read operation, a single write operation, read & write operations, or one of write & read operations. The wireless tag control unit 201 controls a read/write operation for each of the first RW unit 203 and the second RW unit 204. The wireless tag control unit 201 transmits a command on a read/write operation to, for example, the first RW unit 203 and the second RW unit 204. The wireless tag control unit 201 acquires a response to the transmitted command from the first RW unit 203 and the second RW unit 204. The command to be transmitted includes, for example, data to be written in a write operation. In addition, the response to be acquired includes data read from the wireless tag by a read operation. The wireless tag in the embodiment is, for example, a Radio Frequency Identifier (RFID) tag. The first RW unit 203 and the second RW unit 204 perform data read/write operations on the wireless tag using, for example, radio waves for short range wireless communication.

In addition, the first RW unit 203 and the second RW unit 204 can detect a defect of the wireless tag. A defect in the wireless tag is detected, for example, by writing predetermined data, reading the written data, and checking that predetermined data is correctly written. Whether or not data is correctly written can be determined, for example, by reading and checking a predetermined check bit (check digit) included in the wireless tag. If a defect of the wireless tag is detected, the first RW unit 203 and the second RW unit 204 send defect detection information to the wireless tag control unit 201. The wireless tag control unit 201 provides information on defect detection of the wireless tag provided to the control unit 100.

The first RW unit 203 is located at a position before an image is formed on the wireless tag sheet. The position before an image is formed on the wireless tag sheet is, for example, a position between the paper feed cassette 16b and the registration roller 31. The first RW unit 203 performs a read/write operation on the wireless tag, for example, at a position where the wireless tag sheet is stopped by being brought into contact with the registration roller 31. That is, the first RW unit 203 can detect a defect in the wireless tag included in the wireless tag sheet before an image is formed on the wireless tag sheet.

The control unit 100 controls the conveying speed of the wireless tag sheet if the defect of the wireless tag is detected. The control unit 100 controls to lower the conveying speed to zero by stopping the wireless tag sheet at the position of the registration roller 31. However, since the first RW unit 203 can read from and write to the wireless tag at a predetermined distance, the wireless tag sheet need not be completely stopped at the time of reading and writing. That is, the control unit 100 may control the conveying speed of the wireless tag sheet at a conveying speed where the first RW unit 203 can read and write. By lowering the conveying speed, the wireless tag will be in range of the first RW unit 203 for a longer period and so it is possible to reduce the transmission power of the first RW unit 203. By reducing the transmission power of the first RW unit 203, it is possible to reduce power consumption and also prevent erroneous writing to other wireless tags in the vicinity. Accordingly, when power saving is required, the control unit 100 may control to lower the conveying speed of the wireless tag sheet and lower the transmission power of the first RW unit 203.

The second RW unit 204 is located at a position after an image is formed on the wireless tag sheet. The position after an image is formed on the wireless tag sheet is, for example, a position on downstream side of the fixing device 34 and on upstream side of the sheet discharge switching unit 202, in the sheet conveying direction. The second RW unit 204 performs a read/write operation on the wireless tag, for example, at a position along the conveying path 33c. That is, the second RW unit 204 can detect a defect in the wireless tag included in the wireless tag sheet after an image is formed on the sheet. As described above, heat and pressure, which may damage the wireless tag, is applied to the wireless tag sheet in the printer unit 18. The second RW unit 204 can detect a defect of the wireless tag due to the heat and pressure applied in the printer unit 18 that cannot be detected by the first RW unit 203. The wireless tag control unit 201 provides the control unit 100 with information on the defect of the wireless tag detected by the first RW unit 203 or the second RW unit 204.

The control unit 100 controls the conveying speed of the wireless tag sheet if the defect of the wireless tag is detected in the second RW unit 204. For example, the control unit 100 controls to temporarily lower the speed of the conveying roller if a defect of the wireless tag is detected in the second RW unit 204. Similarly to the read/write in the first RW unit 203, the control unit 100 controls the conveying speed of the wireless tag sheet to a conveying speed at which the second RW unit 204 can stably read and write. By lowering the conveying speed, it is possible to reduce the transmission power of the second RW unit 204. By reducing the transmission power of the second RW unit 204, it is possible to reduce power consumption and also prevent erroneous writing to the other wireless tags in the vicinity.

An electrostatic latent image is formed on the photoconductive drum 24 by the exposure scanning head 27 before the toner image formed on intermediate transfer belt 21 is secondarily transferred onto the sheet by the secondary transfer roller 32. The electrostatic latent image formed on the photoconductive drum 24 is developed by development device 28 as a toner image. The toner image formed on the photoconductive drum 24 is primarily transferred to the intermediate transfer belt 21. Further, the toner image primarily transferred to the intermediate transfer belt 21 is secondarily transferred to the wireless tag sheet conveyed to the position of the secondary transfer roller 32. Here, the timing of detecting whether the wireless tag of the wireless tag sheet is defected is defined as a defect detection timing. In addition, the timing for determining an image to be formed on the wireless tag sheet is defined as an image determination timing. Specifically, the image determining timing is a timing earlier than the timing at which scanning to the photoconductive drum 24 by the exposure scanning head 27 is started.

The control unit 100 can change the operation by changing the defect detection timing and the image determining timing. Hereinafter, void printing and defect sorting, in which the defect detection timing and the image determining timing are different, will be described. The void printing is executed in a void printing mode. The defect sorting is executed in a defect sorting mode. The image forming apparatus 10 of the embodiment is operated in four operation modes described later. Here, the void printing mode and the defect sorting mode will be described from the viewpoint of defect detection timing and image determining timing.

The void printing mode is an operation mode in which the defect detection timing is set to be earlier than the image determining timing. In the void printing mode, an image to be formed is determined after the detection of a defect of the wireless tag at the position of the registration roller 31. The void printing refers to printing letters and a defect mark indicating that the wireless tag is defective on the wireless tag sheet in which a defect of the wireless tag is detected. In the void printing, the defect mark is printed on the wireless tag sheet in place of print data (hereinafter, referred to as “normal data”) which is supposed to be printed on the wireless tag sheet originally by replacing the normal data with the defect mark or together with the normal data. In addition, the void printing mode is an operation mode in which the void printing is executed when a defect of the wireless tag is detected. By performing void printing, it is possible to visually check a defect of the wireless tag of the wireless tag sheet based on whether the defect mark is printed on the wireless tag sheet. Accordingly, even if a wireless tag sheet, on which the void printing is performed, is mixed into wireless tag sheets in which defect of the wireless tag is not detected, it is possible to sort out the wireless tag sheet having a defective wireless tag. In addition, in the void printing mode, the normal data that is supposed to be originally printed is printed on the next wireless tag sheet in which defect of the wireless tag is not detected, so no page missing occurs. On the other hand, in the void printing mode, even when printing a plurality of pages, it is not possible to previously forma toner image corresponding to the plurality of pages on the intermediate transfer belt 21. Therefore, the printing speed (PPM) decreases compared to a normal printing mode described later. Here, low-speed printing in the void printing mode refers to low-speed printing. Printing the normal data refers to normal printing. Normal printing is executed in the normal printing mode to be described later.

The defect sorting mode is an operation mode in which the image determining timing is set to be earlier than the defect detection timing. In the defect sorting mode, similar to printing on the regular sheet, an image to be formed on the wireless tag sheet is determined before the wireless tag sheet stops at the position of the registration roller 31. Accordingly, even if a defect of the wireless tag is detected in the first RW unit 203, an image to be formed is already determined. Therefore, in the defect sorting mode, it is not possible to change the image to be printed depending on a result of detection of defect of the wireless tag and the void printing cannot be done. In the defect sorting mode, the control unit 100 switches a discharge destination of the wireless tag sheet in which a defect is detected by the sheet discharge switching unit 202. In the defect sorting mode, it is possible to form a toner image on the intermediate transfer belt 21 in advance when printing a plurality of pages. Therefore, it is possible to print the wireless tag sheet at a printing speed (PPM) at the same speed as printing a regular sheet (normal printing). Printing in the defect sorting mode or high-speed printing in the normal printing refers to high-speed printing. In the defect sorting mode, it is possible to improve the printing speed without mixing a sheet having a defective wireless tag into the printed wireless tag sheets. In the defect sorting mode, a defect of the wireless tag may be detected by the second RW unit 204.

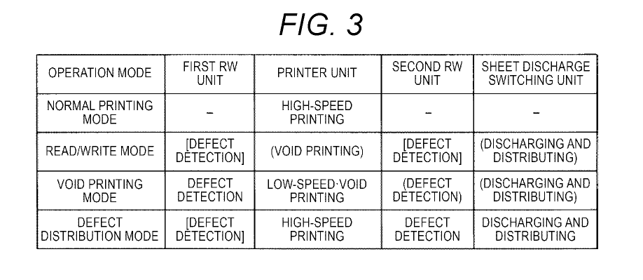

The difference between the operation modes by the defect detection timing and the image determining timing has been described above, but details of the operation mode will be described later with reference to FIG. 3. The wireless tag control unit 201 acquires information about the operation mode from the control unit 100. The wireless tag control unit 201 individually controls the operation of detecting a defect in the first RW unit 203 and the operation of detecting a defect in the second RW unit 204 according to the acquired information about the operation mode.

In addition, in FIG. 1, the case where detection of a defect of the wireless tag is performed by a read/write operation in the reader/writer (the first RW unit 203 or the second RW unit 204) is exemplified. However, a defect of the wireless tag may be detected by a device for detecting defects installed separately from the reader/writer.

The sheet discharge switching unit 202 switches the discharge destination of the wireless tag sheet. The control unit 100 controls switching of the discharge destination in the sheet discharge switching unit 202. For example, if a defect of the wireless tag is not detected by the wireless tag control unit 201, the control unit 100 controls the sheet discharge switching unit 202 so as to discharge the wireless tag sheet to an OK tray 20a. On the other hand, if a defect of the wireless tag is detected, the control unit 100 controls the sheet discharge switching unit 202 to discharge the wireless tag sheet having a defective wireless tag to an NG tray 20b. For example, the sheet discharge switching unit 202 switches the discharge destination to the OK tray 20a or the NG tray 20b, for example, by switching a flap (not illustrated) in a conveying path through which the sheet passes. By switching the discharge destination of the wireless tag sheet in which a defect of the wireless tag is detected by the sheet discharge switching unit 202, the task of sorting out the wireless tag sheet after printing becomes unnecessary. Accordingly, it is possible to prevent a reduction in the work efficiency of the user who prints an image on the wireless tag sheet.

The sheet discharge switching unit 202 has shown the case where the discharge destination is switched between two of the OK tray 20a or the NG tray 20b, but the discharge destination may be switched between, for example, three or more trays. In addition, in printing of regular sheets, the discharge destination may not be switched and all regular sheets may be discharged to the OK tray 20a or the NG tray 20b.

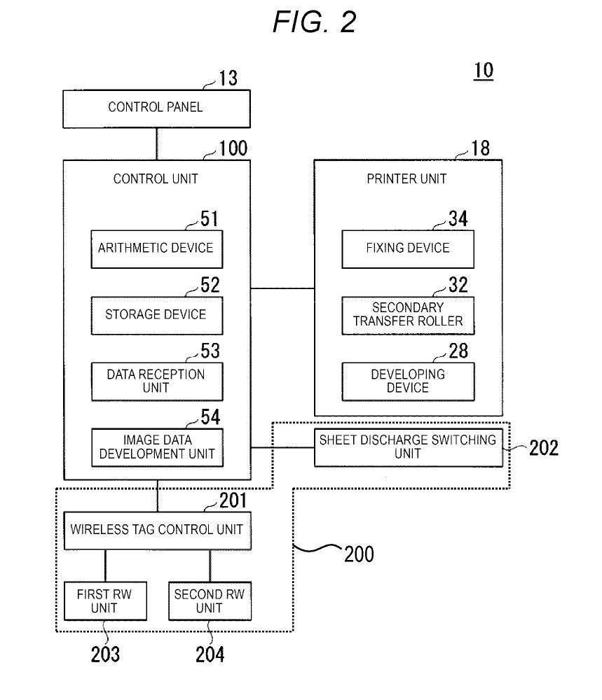

Next, a functional block diagram of the image forming apparatus of the embodiment will be described with reference to FIG. 2.

In FIG. 2, the image forming apparatus 10 includes the control unit 100, the control panel 13, the printer unit 18, the wireless tag control unit 201, the sheet discharge switching unit 202, the first RW unit 203, and the second RW unit 204.

The control unit 100 includes an arithmetic device 51 and a storage device 52. The arithmetic device 51 controls the control panel 13, the printer unit 18, the wireless tag control unit 201, and the sheet discharge switching unit 202 in accordance with an image processing program stored in the storage device 52.

The arithmetic device 51 is, for example, a Central Processing Unit (CPU), an Application Specific Integrated Circuit (ASIC), or the like. The storage device 52 is a Read Only Memory (ROM), a Random Access Memory (RAM), a Hard Disk Drive (HDD), a Solid State Drive (SSD), or the like. A data reception unit 53 receives the print data (for example, data written in a page description language) indicating an image to be printed from a host such as a Personal Computer (PC) and stores the received print data in the storage device 52. An image data development unit 54 determines printing conditions from the print data stored in the storage device 52 by the data reception unit 53, so that the printer unit 18 can develop the data into printable data (for example, raster data or the like) and store the developed data in the storage device 52. In the embodiment, as described above, print data or raster data to be printed in a normal printing operation is referred to as normal data in contrast to data such as the defect mark printed in the void printing.

The printer unit 18 includes the fixing device 34, the secondary transfer roller 32, and the developing device 28. The printer unit 18 forms an image on the sheet based on the normal data stored in the storage device 52 by the image data development unit 54.

The wireless tag control unit 201 controls the first RW unit 203 and the second RW unit 204. The wireless tag control unit 201 operates the first RW unit 203 or the second RW unit 204 based on the operation mode specified by the control unit 100 to detect a defect in the wireless tag. The wireless tag control unit 201 notifies the control unit 100 of the information on the detected defect of the wireless tag. The control unit 100 controls the void printing in the printer unit 18 and the sheet discharge switching in the sheet discharge switching unit 202 based on the notified information on the defect of the wireless tag.

Next, a diagram illustrating the operation mode of the image forming apparatus of the embodiment will be described with reference to FIG. 3.

In FIG. 3, the operation mode is the operation mode of the image forming apparatus 10 set in the control unit 100. For example, the control unit 100 displays the operation mode that can be set selectively on the control panel 13 and controls the operation of the image forming apparatus 10 in the selected operation mode.

The data item of “operation mode” refers to the name of the operation mode. FIG. 3 shows four operation modes, “normal printing mode”, “read/write mode”, “void printing mode”, and “defect sorting mode”. The data items of “first RW unit”, “printer unit”, “second RW unit”, and “sheet discharge switching unit” refer to an operation of each part in each operation mode. The “first RW unit” indicates an operation of the first RW unit 203. The “printer unit” indicates an operation of the printer unit 18. The “second RW unit” indicates an operation of the second RW unit 204. In addition, the “sheet discharge switching unit” indicates an operation of the sheet discharge switching unit 202. Defect detection and read/write operations in the first RW unit 203 and the second RW unit 204 are controlled by the control unit 100 through control by the wireless tag control unit 201. In the following description, it is assumed that defect detection and read/write operations in the first RW unit 203 and the second RW unit 204 are controlled by the control unit 100.

<Normal Printing Mode>

The “normal printing mode” is an operation mode in which normal printing to print the normal data on a regular sheet is performed. In the normal printing mode, reading from or writing to the wireless tag is not executed. When the normal printing mode is selected, the control unit 100 controls the printer unit 18 without using “the first RW unit” and “the second RW unit”. In addition, when the normal printing mode is selected, the control unit 100 operates the “printer unit” in high-speed printing as described above. Here, the high-speed printing is printing at a high printing speed (PPM) compared to low-speed printing and is not defined by an absolute numerical value. In high-speed printing, the control unit 100 starts to form a toner image on the intermediate transfer belt 21 before the regular sheet stops at the registration roller 31 in order to improve the printing speed. The control unit 100 discharges the regular sheet printed in the normal printing mode to the OK tray 20a.

<Read/Write Mode>

The “read/write mode” is an operation mode in which data is read from or written to the wireless tag of the wireless tag sheet. In the read/write mode, normal printing is not performed in the printer unit 18. When the read/write mode is selected, the control unit 100 performs an operation to detect a defect of the wireless tag in at least one of “the first RW unit” or “the second RW unit”. The indication of “[ ]” in the data item of “the first RW unit” and the data item of “the second RW unit” refers to a selection operation in which at least one thereof is operated for the defect detection operation. For example, in the read/write mode, the control unit 100 controls only the first RW unit 203 to detect a defect of the wireless tag. On the other hand, in the read/write mode, the control unit 100 may control only the second RW unit 204 to detect a defect of the wireless tag. Further, in the read/write mode, the control unit 100 may control both the first RW unit 203 and the second RW unit 204 to detect a defect of the wireless tag.

The selection operation and an arbitrary operation to be described below may be set from the control panel 13, for example, in the same way as selecting the operation mode. For example, the control panel 13 displays which operation among the selection operations is to be selected in a settable manner. In addition, the control panel 13 displays whether or not to operate an arbitrary operation in a settable manner. The control unit 100 controls the operations in the “first RW unit”, the “printer unit”, the “second RW unit”, and the “sheet discharge switching unit” based on the set selection operation or an arbitrary operation.

In addition, in the read/write mode, the control unit 100 reads from or writes to the wireless tag by at least one of the first RW unit 203 and the second RW unit 204. That is, an operation of the read/write operation and an operation of detecting a defect may be executed in either the first RW unit or the second RW unit. For example, the control unit 100 may control the first RW unit 203 to read from or write to the wireless tag in order to detect a defect of the wireless tag of the wireless tag sheet. In addition, the control unit 100 may control the second RW unit 204 to read from or write to the wireless tag in order to detect a defect of the wireless tag of the wireless tag sheet. In addition, the control unit 100 may perform a read/write operation on the wireless tag using the first RW unit 203 and control detection operation in order to detect a defect of the wireless tag of the wireless tag sheet using the second RW unit 204.

In the read/write mode, normal printing is not performed in the printer unit 18 as described above. However, when the read/write mode is selected, the control unit 100 may execute void printing if a defect of the wireless tag is detected in the “first RW unit”. The indication of “( )” in each data item refers to an arbitrary operation capable of arbitrarily setting whether or not to be operated. That is, in the read/write mode, the void printing in the “printer unit” is an arbitrary operation. In order to perform the void printing, low-speed printing is executed as in the void printing mode as described above. In addition, in the read/write mode, discharging and sorting in the “sheet discharge switching unit” is also an arbitrary operation. If a defect of the wireless tag is detected only in “the second RW unit”, by executing discharging and sorting in the “sheet discharge switching unit”, the wireless tag sheet where a defect is detected in the wireless tag is guided toward the NG tray 20b. If void printing is not executed, it is not necessary to execute low-speed printing. Accordingly, when executing discharging and sorting without executing the void printing, processing can be executed at a speed at which the wireless tag can be stably read or written (the number of read/write sheets per minute).

<Void Printing Mode>

The “void printing mode” is an operation mode in which both printing of the normal data onto the wireless tag sheet at a low speed and reading/writing from or to a wireless tag of the wireless tag sheet are performed. In the void printing mode, the detection operation to detect the defects of the wireless tag is always executed in “the first RW unit”. In addition, in the void printing mode, low-speed printing of normal data or void printing is executed in the “printer unit”. That is, in the void printing mode, if a defect of the wireless tag is not detected in “the first RW unit”, low-speed printing of the normal data is executed in the “printer unit”. In addition, in the void printing mode, if a defect of the wireless tag is detected in “the first RW unit”, void printing is executed in the “printer unit”.

In the void printing mode, defect detection in “the second RW unit” is an arbitrary operation. By operating “the second RW unit”, it is possible to detect a defect (damage) of the wireless tag after the image formation in the printer unit 18 as described above. In addition, in the void printing mode, discharging and sorting in the “sheet discharge switching unit” is also an arbitrary operation. By discharging and sorting the void printed wireless tag sheet, the task of sorting out the wireless tag sheet becomes unnecessary and work efficiency improves.

<Defect Sorting Mode>

The “defect sorting mode” is an operation mode in which both printing of the normal data at a high speed and reading/writing from or to a wireless tag are performed on a wireless tag sheet. In the defect sorting mode, defect detection in “the first RW unit” is an arbitrary operation. In the defect sorting mode, high-speed printing is executed in “the printer unit”. In the defect sorting mode, void printing is not executed even if a defect of the wireless tag is detected in “the first RW unit”.

In the defect sorting mode, defect detection is always executed in “the second RW unit”. In addition, in the defect sorting mode, discharging and sorting is always executed in the “sheet discharge switching unit”. The discharging and sorting in the “sheet discharge switching unit” is executed if a defect of the wireless tag is detected in “the first RW unit” (arbitrary operation) or “the second RW unit”. Since the normal data can be printed at a high speed in the defect sorting mode, it is possible to improve the productivity of printing to the wireless tag sheet. In addition, in the defect sorting mode, discharging and sorting is always executed in the “sheet discharge switching unit”. Therefore, the task of sorting out the wireless tag sheet where a defect is detected becomes unnecessary and work efficiency improves. That is, in the defect sorting mode, it is possible to improve the workability and further improve the printing speed without a sheet with a defective wireless tag being mixed into the printed wireless tag sheets.

The operation in each of the above-described operation modes is merely an example and does not limit the operation of the image forming apparatus 10 in the embodiment. For example, the image forming apparatus 10 may have an operation mode to perform normal printing on a wireless tag sheet.

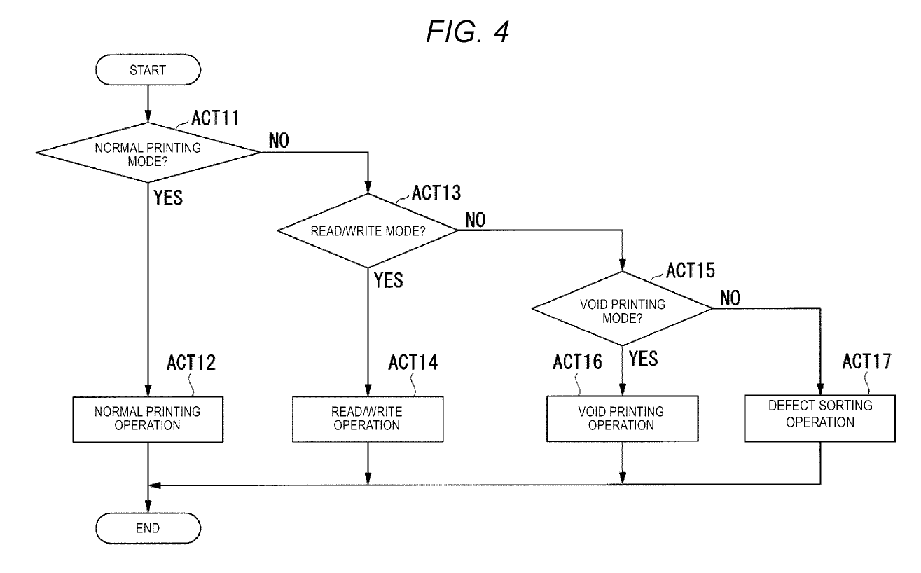

Next, a flowchart depicting the operation of the image forming apparatus 10 of the embodiment of will be described with reference to FIG. 4. The operation of the flowchart shown in FIG. 4 is executed in the control unit 100.

In FIG. 4, the control unit 100 determines whether or not the operation mode is the normal printing mode (Act11). The determination as to whether or not the operation mode is the normal printing mode can be made, for example, by the operation mode set from the control panel 13. If it is determined that the operation mode is the normal printing mode (Act11: YES), the control unit 100 performs operation control according to the normal printing mode described in FIG. 3 (Act12).

On the other hand, if it is determined that the operation mode is not the normal printing mode (Act11: NO), the control unit 100 determines whether or not the operation mode is the read/write mode (Act13). If it is determined that the operation mode is the read/write mode (Act13: YES), the control unit 100 performs operation control according to the read/write mode (Act14).

On the other hand, if it is determined that the operation mode is not the read/write mode (Act13: NO), the control unit 100 determines whether or not the operation mode is the void printing mode (Act15). If it is determined that the operation mode is the void printing mode (Act15: YES), the control unit 100 performs operation control according to the void printing mode (Act16).

On the other hand, if it is determined that the operation mode is not the void printing mode (Act15: NO), the control unit 100 performs motion control according to the defect sorting mode (Act17). After executing the processing of Act12, Act14, Act16 or Act17, the control unit 100 ends the processing shown in the flowchart.

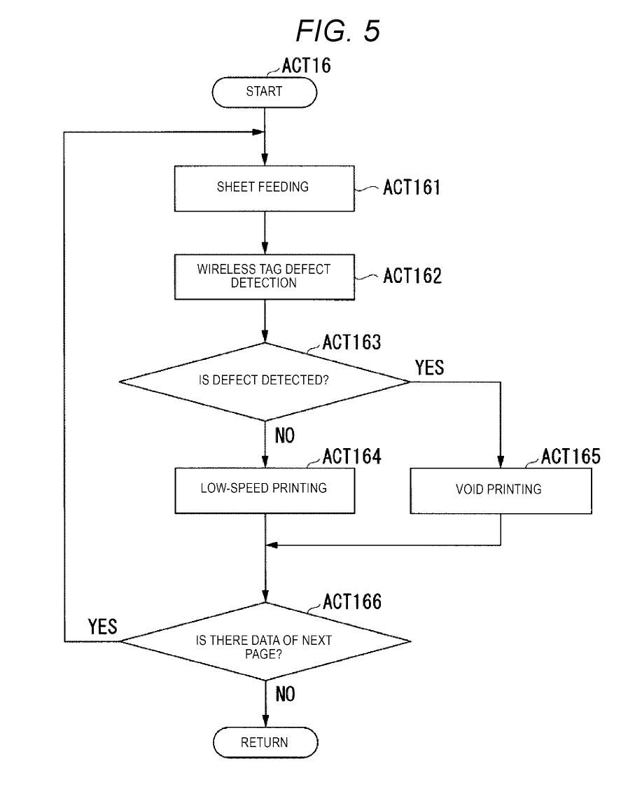

Next, a flowchart depicting the void printing operation of the image forming apparatus 10 of the embodiment will be described with reference to FIG. 5. The flowchart shown in FIG. 5 is the details of the processing of Act16 in FIG. 4.

In FIG. 5, the control unit 100 executes sheet feeding (Act161). The sheet feeding is processing of feeding the wireless tag sheet from the paper feed cassette 16b described in FIG. 1. After executing the processing of Act161, the control unit 100 performs detection operation to detect a defect of the wireless tag in the first RW unit 203 (Act162). Detecting a defect of the wireless tag is performed on the wireless tag of the wireless tag sheet which is stopped at the position of the registration roller 31 by the read/write operation from the first RW unit 203, for example.

After executing the processing of Act162, the control unit 100 determines whether or not a defect of the wireless tag is detected (Act163). Whether or not a defect is detected in the wireless tag can be determined from the predetermined check bit included in the wireless tag, for example. The check bit is, for example, a check digit for error correction or error detection. The wireless tag control unit 201 includes the check digit in the data written to the wireless tag from the first RW unit 203. Next, the wireless tag control unit 201 reads the written check digit using the first RW unit 203. The wireless tag control unit 201 detects an error in data based on a numerical value of the read check digit. The control unit 100 acquires a result detected by the wireless tag control unit 201 and, if there is an error in the data of the check digit, determines that the wireless tag is defective. The check digit may be a value obtained by reading an initial value written in the wireless tag. That is, the control unit 100 may determine the detection of a defect of the wireless tag without writing data to the wireless tag. In addition, the control unit 100 may rewrite correct data when it is possible to correct the error of the written data. The control unit 100 detects an error of the written data again.

If it is determined that defect is not detected in the wireless tag (Act163: NO), the control unit 100 instructs the printer unit 18 to execute low-speed printing (Act164). The low-speed printing is processing of printing the normal data at a low speed on the wireless tag sheet. The normal data is, for example, data such as commodity name, commodity code, serial number, and the like printed on the wireless tag sheet. The normal data has one page of data for one wireless tag sheet. The normal data may have data of a plurality of pages.

If it is determined that a defect is detected in the wireless tag (Act163: YES), the control unit 100 instructs the printer unit 18 to execute void printing (Act165). The void printing is processing of printing the defect mark such as “defective” on the wireless tag sheet, for example. The development of the image of the defect mark is started after a defect of the wireless tag is detected. The wireless tag sheet waits at the position of the registration roller 31 until a toner image can be transferred onto the wireless tag sheet by the secondary transfer roller 32 after a defect of the wireless tag is detected. Since the printing speed (PPM) includes the waiting time, the printing speed is lowered.

After executing the processing of Act164 or Act165, the control unit 100 determines whether or not there is data of the next page in the normal data (Act166). That is, the control unit 100 counts the number of pages (or the number of unprinted pages) on which printing has been completed among a plurality of pages included in the normal data. If it is determined that there is data of the next page in the normal data (Act166: YES), the control unit 100 returns to Act161 and executes the processing thereof. That is, in the void printing operation, the control unit 100 starts to feed the next wireless tag sheet after completing low-speed printing or void printing. Accordingly, it is possible to perform void printing if a defect of the wireless tag is detected. On the other hand, if it is determined that there is no data of the next page in the normal data (Act166: NO), the control unit 100 ends the processing of Act16 shown in the flowchart.

In the void printing mode shown in FIG. 5, the case where a defect detection operation of the wireless tag in the second RW unit 204 and an operation of discharging and sorting in the sheet discharge switching unit 202 are not performed is described. However, as described above, in the void printing mode, the defect detection operation of the wireless tag in the second RW unit 204 and the discharging and sorting in the sheet discharge switching unit 202 are arbitrary operations. Accordingly, the operation in the void printing mode may include the defect detection operation of the wireless tag in the second RW unit 204. In addition, the operation in the void printing mode may include the operation of discharging and sorting in the sheet discharge switching unit 202.

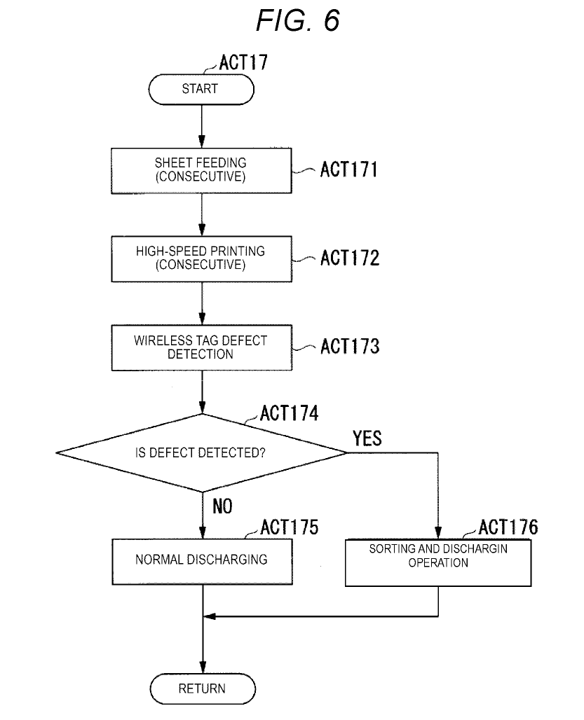

Next, a flowchart depicting the defect sorting operation of the image forming apparatus 10 of the embodiment will be described with reference to FIG. 6. The flowchart shown in FIG. 6 is the details of the processing of Act17 in FIG. 4.

In FIG. 6, the control unit 100 executes sheet feeding (Act171). The sheet feeding in Act171 is sheet feeding at a timing that the wireless tag sheet can be fed from the paper feed cassette 16b. The timing at which wireless tag sheets can be fed from the paper feed cassette 16b to the conveying path 33a is a timing at which a wireless tag sheet does not interfere with the wireless tag sheet on the previous page. For example, it is the time when the wireless tag sheet of the previous page is conveyed from the position of the registration roller 31 and does not interfere with the wireless tag sheet of the next page. That is, the sheet feeding of Act171 can be executed consecutively as compared with sheet feeding of Act161.

After executing the processing of Act171, the control unit 100 instructs the printer unit 18 to execute high-speed printing (Act172). The high-speed printing is processing of printing the normal data at a high speed on the wireless tag sheet. The normal data is the same as the data to be printed at a low speed. However, in the defect sorting operation of FIG. 6, the first RW unit 203 does not detect a defect of the wireless tag. Therefore, void printing is not performed even for an initial defective wireless tag sheet and the normal data is printed consecutively.

After executing the processing of Act172, the control unit 100 performs detection operation to detect a defect of the wireless tag (Act173). Presence or absence of a defect in the wireless tag is detected, for example, in the second RW unit 204 located on downstream side of the printer unit 18 and disposed on upstream side of the sheet discharge switching unit 202. The second RW unit 204 writes data to the wireless tag of the wireless tag sheet and reads the data written to the wireless tag. The operation of the second RW unit 204 is similar to that of the first RW unit 203.

After executing the processing of Act173, the control unit 100 determines whether or not a defect is detected in the wireless tag (Act174). The determination as to whether or not a defect is detected in the wireless tag is the same as the determination in the processing of Act163. Since the second RW unit 204 is located at a position on downstream side of the printer unit 18, in the defect sorting mode, for example, it is possible to detect the wireless tag damaged by the heat or pressure applied in the fixing device 34.

If it is determined that no defect is detected in the wireless tag (Act174: NO), the control unit 100 normally discharges the sheet (Act175). Normally discharging is processing of discharging the wireless tag sheet to the OK tray 20a. On the other hand, if it is determined that a defect is detected in the wireless tag (Act174: YES), the control unit 100 sorts and discharges the sheet (Act176). Sorting and discharging is processing of discharging the wireless tag sheet including the wireless tag in which a defect is detected to the NG tray 20b. After executing the processing of Act175 or the processing of Act175, the control unit 100 ends the process of Act17 shown in the flowchart.

In the processing of the defect sorting mode shown in FIG. 6, the normal data is already printed on the wireless tag sheet where a defect is detected in the wireless tag. Therefore, in the OK tray 20a, the page of the wireless tag sheet discharged to the NG tray 20b is missing. The control unit 100 may reprint the page corresponding to the wireless tag sheet discharged to the NG tray 20b. On the reprinted wireless tag sheet, the normal data of the missing page is printed, and data corresponding to that page is written to the wireless tag. If a defect of the wireless tag is detected in reprinting, the image of the page corresponding to the wireless tag sheet on which the defect is detected may be further reprinted. The reprinted wireless tag sheet is discharged to the OK tray 20a. Therefore, in order to correct missing of a page, an operation of inserting a reprinted page into a missing page occurs.

In addition, in the defect sorting mode shown in FIG. 6, a case where the defect detection operation of the wireless tag in the first RW unit 203 is not performed is shown. However, in the defect sorting mode as described above, the defect detection operation of the wireless tag in the first RW unit 203 is an arbitrary operation. Accordingly, the operation in the defect sorting mode may include a defect detection operation of the wireless tag in the first RW unit 203.

All or a part of each function of the image forming apparatus 10 may be implemented by using hardware such as an ASIC, a programmable logic device (PLD), a field-programmable gate array (FPGA), or the like. The program for controlling the image forming apparatus 10 may be recorded on a computer-readable recording medium. The computer-readable recording medium is, for example, a portable medium such as a flexible disk, a magneto-optical disk, a ROM, a CD-ROM or the like, or a storage device such as a hard disk built in a computer system. The image processing program may be transmitted via an electric communication line.

In addition, although the developing method of the printer unit 18 of the image forming apparatus 10 has been described as being a tandem developing method, the developing method of the image forming apparatus 10 is not limited thereto. The developing method of the image forming apparatus 10 may be, for example, a four-cycle method. In addition, the number of developing devices is not limited. Further, the image forming apparatus 10 may use another printing method such as an ink jet method for the printer unit.

The above-described image forming apparatus of the embodiment includes a printer unit that executes an image forming operation on a sheet, a first read/write unit that executes a read/write operation that performs at least one of reading or writing data from or to a wireless tag included in the sheet before the image forming operation is executed, a second read/write unit that executes the read/write operation after the image forming operation is executed, and a control unit that controls the printer unit, the first read/write unit, and the second read/write unit, in which the control unit causes a defect detection operation to detect a defect of the wireless tag at least in the second read/write unit. With this configuration, it is possible to improve the printing speed without a sheet with a defective wireless tag being mixed into the printed sheets.

In addition, in the image forming apparatus of the embodiment, the control unit controls the printer unit, the first read/write unit and the second read/write unit in one of the following operation modes. The operation mode includes an operation mode in which an image forming operation is executed without executing a read/write operation. In addition, the operation mode includes an operation mode in which a read/write operation is executed without executing an image forming operation. In addition, the operation mode includes an operation mode in which both the image forming operation and the read/write operation are executed. With this configuration, the image forming apparatus enables image formation according to the operation mode desired by the user.

In addition, in the image forming apparatus of the embodiment, the control unit controls the printer unit so as to form an image of the defect mark indicating a defect of the wireless tag on the sheet if a defect is detected in the first read/write unit. With this configuration, the image forming apparatus can form an image of the defect mark on the sheet.

In addition, the image forming apparatus of the embodiment further includes a sheet discharge switching unit that switches a discharge destination of a sheet, in which the control unit controls the sheet discharge switching unit so as to switch the discharge destination of the sheet if a defect is detected in the second read/write unit.

With this configuration, the task of sorting out the printed sheet becomes unnecessary, and work efficiency and the printing speed improve.

In addition, in the image forming apparatus of the embodiment, the control unit changes the conveying speed of the sheet if a defect is detected. With this configuration, power saving and erroneous writing to the tag in the vicinity can be prevented.

According to at least one embodiment described above, the image forming apparatus of the embodiment includes the printer unit, the first read/write unit, the second read/write unit, and the control unit. With this configuration, it is possible to improve the printing speed without a sheet with a defective wireless tag being mixed into the printed sheets.

In addition, by executing a program for implementing the functions of the device described in the embodiment, the above-described various processing of the embodiment may be performed. The program to be executed may be recorded in a computer-readable recording medium and the program recorded in the recording medium may be read into a computer system. The “computer system” referred to here may include hardware such as an OS and peripheral devices. In addition, the “computer system” also includes a homepage providing environment (or display environment) as long as the computer system uses the WWW system. In addition, the “computer-readable recording medium” is, for example, a writable nonvolatile memory such as a flexible disk, a magneto-optical disk, ROM, a flash memory, or the like. The computer-readable recording medium may be a portable medium such as a CD-ROM or a storage device such as a hard disk embedded in a computer system.

Further, the “computer-readable recording medium” includes a medium holding a program for a certain period of time. The computer-readable recording medium is, for example, a volatile memory inside a computer system serving as a server or a client when the program is transmitted via a communication line. The communication line is, for example, a network such as the Internet, a telephone line, or the like. The volatile memory is, for example, a Dynamic RAM (DRAM). In addition, the above-described program may be transmitted from the computer system storing the program in a storage device or the like to another computer system. The program is transmitted, for example, via a transmission medium or by a transmission wave in the transmission medium. Here, the “transmission medium” that transmits the program refers to a medium having a function of transmitting information. The transmission medium is, for example, a network (communication network) such as the Internet or a communication line (communication line) such as a telephone line. In addition, the above-described program may be a program for implementing part of the above-described functions. Further, a so-called difference file (difference program) which implements the above-described functions in combination with a program already recorded in the computer system may be used.

While the embodiments have been described referring to the drawings, these embodiments have been presented byway of example only, and are not intended to limit the scope of the inventions. Indeed, the novel embodiment described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image forming unit configured to execute an image forming operation on a sheet;
a first reader/writer device configured to execute a wireless read/write operation on a wireless tag and positioned in a sheet conveying path upstream of the image forming unit;
a second reader/writer device configured to execute a wireless read/write operation on a wireless tag and positioned in the sheet conveying path downstream of the image forming unit; and
a control unit configured to control the image forming unit, the first reader/writer device, and the second reader/writer device,
wherein the control unit controls the second reader/writer device to perform an operation to detect a defect in a wireless tag that is included in a sheet as the sheet is conveyed along the sheet conveying path past the location of the second reader/writer device.

2. The apparatus according to claim 1,
wherein the control unit controls the image forming unit, the first reader/writer device, and the second reader/writer device in any one of an operation mode in which an image forming operation is executed and not the reader/writer operation, an operation mode in which the reader/writer operation is executed and not the image forming operation, and an operation mode in which both the image forming operation and the reader/writer operation are executed.

3. The apparatus according to claim 1,
wherein the control unit controls the first reader/writer device to perform an operation to detect a defect in a wireless tag that is included in a sheet as the sheet is conveyed along the sheet conveying path past the location of the first reader/writer device.

4. The apparatus according to claim 3,
wherein the control unit controls the image forming unit to form an image of a defect mark on the sheet indicating a defect in the wireless tag if the defect is detected by the first reader/writer device.

5. The apparatus according to claim 3,
wherein the control unit changes a conveying speed of the sheet when the sheet is conveyed along the sheet conveying path past the location of the first reader/writer device.

6. The apparatus according to claim 3,
wherein the control unit changes a conveying speed of the sheet when the sheet is conveyed along the sheet conveying path past the location of the second reader/writer device.

7. The apparatus according to claim 1, further comprising:
a sheet discharge switching unit configured to switch a discharge destination of the sheet,
wherein the control unit controls the sheet discharge switching unit so as to switch the discharge destination of the sheet if the defect is detected by the second reader/writer unit.

8. An image forming apparatus comprising:
an image forming unit configured to execute an image forming operation on a sheet;
a first reader/writer device configured to execute a wireless read/write operation on a wireless tag and positioned in a sheet conveying path upstream of the image forming unit;
a second reader/writer device configured to execute a wireless read/write operation on a wireless tag and positioned in the sheet conveying path downstream of the image forming unit; and
a control unit configured to control the first reader/writer device to perform a first operation to detect a defect in a wireless tag that is included in a sheet as the sheet is conveyed along the sheet conveying path past the location of the first reader/writer device, and to control the second reader/writer device to perform a second operation to detect a defect in a wireless tag that is included in the sheet as the sheet is conveyed along the sheet conveying path past the location of the second reader/writer device.

9. The apparatus according to claim 8, wherein
the control unit decreases a conveying speed of the sheet when the sheet is conveyed along the sheet conveying path past the location of the first reader/writer device, increases the conveying speed when the sheet is conveyed along the sheet conveying path past the location of the image forming unit, and decreases the conveying speed when the sheet is conveyed along the sheet conveying path past the location of the second reader/writer device.

10. The apparatus according to claim 9,
wherein the control unit controls the image forming unit to form an image of a defect mark on the sheet indicating a defect in the wireless tag if the defect is detected by the first reader/writer device.

11. The apparatus according to claim 10, further comprising:
a sheet discharge switching unit configured to switch a discharge destination of the sheet,
wherein the control unit controls the sheet discharge switching unit so as to switch the discharge destination of the sheet if the defect is detected by the second reader/writer unit.

12. A method for controlling an image forming apparatus having an image forming unit configured to execute an image forming operation on a sheet, a first reader/writer device configured to execute a wireless read/write operation on a wireless tag positioned in a sheet conveying path upstream of the image forming unit, and a second reader/writer device configured to execute a wireless read/write operation on a wireless tag and positioned in the sheet conveying path downstream of the image forming unit, the method comprising:
conveying the sheet past the first reader/writer device and the image forming unit towards a location of the second reader/writer device; and
controlling the second reader/writer device to perform an operation to detect a defect in a wireless tag that is included in a sheet as the sheet is conveyed along the sheet conveying path past the location of the second reader/writer device.

13. The method according to claim 12, further comprising
controlling the image forming unit, the first reader/writer device, and the second reader/writer device in any one of an operation mode in which an image forming operation is executed and not the reader/writer operation, an operation mode in which the reader/writer operation is executed and not the image forming operation, and an operation mode in which both the image forming operation and the reader/writer operation are executed.

14. The method according to claim 12, further comprising
controlling the first reader/writer device to perform an operation to detect a defect in a wireless tag that is included in a sheet as the sheet is conveyed along the sheet conveying path past the location of the first reader/writer device.

15. The method according to claim 14, further comprising
controlling the image forming unit to form an image of a defect mark on the sheet indicating a defect in the wireless tag if the defect is detected by the first reader/writer device.

16. The method according to claim 14, further comprising
changing a conveying speed of the sheet when the sheet is conveyed along the sheet conveying path past the location of the first reader/writer device.

17. The method according to claim 14, further comprising
changing a conveying speed of the sheet when the sheet is conveyed along the sheet conveying path past the location of the second reader/writer device.

18. The method according to claim 12, wherein
the image forming apparatus further comprises a sheet discharge switching unit configured to switch a discharge destination of the sheet, and
the method further comprises controlling the sheet discharge switching unit so as to switch the discharge destination of the sheet if the defect is detected by the second reader/writer unit.
